(19) United States
(12) Patent Application Publication
(10) Pub. No.: US 2010/0273121 A1
(43) Pub. Date: Oct. 28, 2010

(54) OVEN EXHAUST FAN SYSTEM AND METHOD

(76) Inventors: James M. Gleason, Newburgh, IN (US); Thomas S. Neeley, Newburg, IN (US); Samuel L. Woehler, Evansville, IN (US)

Correspondence Address: BARNES & THORNBURG LLP, 11 SOUTH MERIDIAN, INDIANAPOLIS, IN, 46204, US

(21) Appl. No.: 12/430,158

(22) Filed: Apr. 27, 2009

(51) Int. Cl. F27D 7/04; F27D 19/00

(52) U.S. Cl. 432/4; 432/48

(57) ABSTRACT

An oven apparatus has an oven enclosure with a heating zone and has two fans that remove air from the heating zone during purging and during normal operations. One of the two fans, called the exhaust fan, is a fixed speed fan in some embodiments. The second fan is a variable speed fan in some embodiments. The oven apparatus may have a vestibule at a conveyor opening with a fan dedicated to exhausting the vestibule. The oven apparatus may have an air seal between the vestibule and a heating zone of an oven chamber.

### BACKGROUND

The present disclosure relates to ovens that are used to heat treat materials or cure coated parts while conserving energy. More particularly, the present disclosure relates to oven exhaust fan systems and related methods.

Typically, ovens using combustible gases such as direct natural gas fired ovens and ovens that use propane may be “purged” prior to lighting the burner. This is to remove any natural gas that may have accumulated in the oven when the burner was off. Purge is sometimes defined, in some standards, as removing an amount of air from the oven equal to four times the volume of the oven. Applications in which purge is defined by some multiple, or fraction, of the oven volume other than four are contemplated by this disclosure. The removal of this air during purge may be accomplished by means of an exhaust fan, or a purge fan, or a combination of these or other fans. With regard to ovens that include an exhaust fan and one or more separate purge fans, because exhaust fans are constantly running during the normal operation of the oven, the separate purge fan(s) usually run for only a short time while the oven is being purged.

Typically, direct natural gas fired ovens have one or more exhaust fans that remove products of combustion released during the heating process. Exhaust air volume requirements, or combustion air requirements, are established by regulatory bodies such as the National Fire Protection Agency (NFPA). Thus, purge requirements and combustion air requirements may be defined by the National Fire Protection (NFPA) or by another similar type of regulatory body.

If a coating on a part will release solvents or combustible constituents in the oven, the oven exhaust must limit the concentration of solvent by removing the solvent laden air from the oven and drawing fresh air into the oven in order to be compliant with a “solvent removal” or solvent air requirement which is also commonly established by regulatory bodies such as the NFPA. The solvent load on an oven may vary based on the coatings, part surface area, and conveyor speed. The amount of air to be removed is typically designed at a maximum capacity regardless of the actual load being processed, creating an inherent waste of energy in exchange for safe operation. The waste occurs because more fuel, such as natural gas, for example, is needed to heat the oven to the desired temperature when more air is exhausted from the oven than really needs to be exhausted.

Exhaust fans must turn at a minimum speed in order to meet regulatory or insurance underwriter requirements. The intent of this minimum speed requirement is to ensure that the fans will have an adequate pressure characteristic for normal safety ventilation even when the facility in which the oven may be located has a negative pressure. This minimum speed requirement prohibits, or at least severely limits the ability to use variable speed control for the exhaust fans of ovens.

In addition to the purge requirement, the combustion air requirement, and the solvent removal requirement, oven exhaust fans may be used to accomplish other functions which are not governed by regulatory or insurance underwriter requirements. Heat treating parts or curing coatings can result in the release of smoke or other contaminants. Exhausting oven air and drawing fresh air into the oven reduces the concentration of such contaminants. The exchange of air needed to control the concentration of contaminants is called oven exhaust turnover. If the exhaust from the oven does not produce sufficient turnover, the coating on the parts may be discolored or otherwise adversely affected by the contaminants to which the parts are exposed in the oven. The turnover requirement may vary depending on the coating used, the coating thickness, and square footage processed in the oven, the color of the parts, or many other reasons. Thus, determining the turnover requirement for any particular application may occur on a trial and error basis. Accordingly, it is possible that the turnover requirement may exceed the exhaust requirement which, in turn, increases the amount of heat needed by the process, thereby requiring additional fuel to maintain the needed or desired oven temperature.

It is common for parts to be heated in an oven as part of a manufacturing process. There are a variety of means of conveying parts into the oven, typically through an opening in the oven that remains open continuously. Such conveying means may include conveyor belts and overhead conveyors. Openings into ovens, especially those in sidewalls, tend to exchange air with the ambient surroundings due to a chimney effect in which hot, low density air may come out of the top of the opening while colder, higher density air may push into the oven at the bottom of the opening. It is generally not desired to have hot, contaminated oven air spilling out of oven openings into a building for safety, energy consumption, and aesthetic reasons. Oven exhaust fans may therefore be sized to draw air into the oven conveyor openings to contain the oven atmosphere, which results in the consumption of even more energy. Air seals may also be used to reduce the exchange at an opening. Air seals may have fans and ducting in a variety of configurations.

While exhausting heated air may help all of these requirements (combustion air, purge, solvent removal, turnovers, and containment), it also increases operating cost due to the increased fuel consumption that results. In fact, on a typical finishing system, up to 44% of all heat may go into air that is exhausted. Thus, exhaust air can be one of the largest consumers of oven heat and leads to increased consumption of fuel or gas by the oven to maintain the oven temperature. Accordingly, an oven that is less expensive to operate due to reducing the amount of fuel needed to heat the oven may be desirable.

The addition of the word “requirement” herein to the commonly understood terms “turnovers,” “containment,” “combustion air,” “solvent removal,” and “purge,” is simply intended to refer to the amount of exhaust needed to result in satisfactory performance of these functions.

### SUMMARY

An oven in accordance with the present disclosure may comprise an apparatus or method that has one or more of the features listed in the appended claims, or one or more of the following features or combinations thereof, which alone or in any combination may comprise patentable subject matter.

The oven apparatus may comprise an enclosure or housing through which parts may be conveyed for heat treatment or coating curing. The oven apparatus may comprise two or more fans that remove air from a heating zone of the oven enclosure and that operate during purging and during normal operation. The primary fan, called the exhaust fan, may operate at a fixed speed and may be sized to meet combustion air, solvent removal requirements, and fan speed rules. One or more secondary or auxiliary fans may be variable speed fans. The secondary fan or fans may be sized to provide the difference between the flow generated by the exhaust fan and the flow required for purge or turnover requirements. During purge, this fan may run at its maximum speed, which will minimize the purge time. Once the purge time is complete, it may be used for turnovers, which is not governed by regulatory bodies or insurance underwriters. Therefore, during operation its speed may be varied and adjusted down to minimize energy consumption, thereby reducing fuel consumption.

The enclosure may optionally comprise a vestibule at each conveyor opening with one or more fans dedicated to exhausting the air from these vestibules to help capture heated or contaminated air lost from the oven heating chamber. Exhausting the vestibules does not need to meet any of the combustion air, solvent removal, purge, or turnover requirements because air is not drawn from the oven but rather from the facility through the conveyor opening(s). Because the one or more vestibule exhaust fans are not used to meet these requirements, the rules for fan speed do not apply to them, and they may be adjusted using a variable frequency drive to optimize containment and minimize energy loss.

The oven apparatus optionally may comprise an air seal between the vestibule and the oven chamber. When present, this air seal helps to reduce the exchange of air from the oven chamber to the vestibule and promotes temperature uniformity in the oven chamber.

Thus, according to this disclosure, an oven apparatus may be optimized to meet all requirements while using a minimum amount of energy, or at least a reduced amount of energy, as compared to known prior art systems.

According to this disclosure, therefore, an apparatus for heating and/or curing products may comprise an oven enclosure having an oven chamber with a heating zone in which products are heated or cured, an exhaust fan that extracts air from the heating zone of the oven chamber and at least one auxiliary fan that extracts air from the heating zone of the oven chamber. The exhaust fan may be a fixed speed fan and the at least one auxiliary fan may be a variable speed fan.

The apparatus may further optionally comprise at least one vestibule within the oven chamber. The vestibule may be situated at an opening in the oven enclosure through which products enter or exit the oven chamber. In some embodiments, a first vestibule may be provided at the entrance end of the oven chamber and a second vestibule may be provided at the exit end of the oven enclosure. At least one vestibule fan may be provided to extract air from the at least one vestibule to capture at least a portion of the oven atmosphere before the oven atmosphere escapes the opening of the oven enclosure.

Optionally, at least one air seal fan that creates at least one barrier to heat loss within the oven chamber may be provided. The at least one barrier may be situated between the at least one vestibule and the heating zone of the oven chamber. The air exhausted from the barrier of the oven chamber by the air seal fan may be re-circulated back into the oven chamber. For example, the air seal fan may be mounted to a top wall of the oven enclosure and the air re-circulated by the air seal fan may enter the barrier of the oven chamber near a bottom of the oven chamber.

The speed of the auxiliary fan may be increasable to increase oven exhaust turnover and decreasable to decrease energy use. The at least one vestibule fan may also be an adjustable speed fan. The speed of the vestibule fan may be increasable to increase vestibule exhaust so as to capture and remove an increased amount of contaminants and heat and may be decreasable to improve energy use. The at least one air seal fan, when present, may be a fixed speed fan. Variable frequency drives may be provided to vary the speed of the auxiliary fan and the at least one vestibule fan. The exhaust fan, the at least one auxiliary fan, the at least one vestibule fan, and the at least one air seal fan may each be mounted to the top wall of the oven enclosure.

The exhaust fan may have the capacity to operate so as to meet a combustion air requirement or a solvent removal requirement, whichever is larger. The at least one vestibule fan may have the capacity to operate so as to meet a containment requirement. The at least one auxiliary fan may have the capacity to operate so as to meet a turnover requirement or a purge requirement, whichever is larger, minus the larger of the combustion air requirement and the solvent removal requirement.

The variable speed fans, such as the at least one vestibule fan and/or the at least one auxiliary fan may be controlled based on feedback from sensors. For example, the opacity of the oven exhaust may be measured as a way of determining a characteristic, such as a concentration, of contaminants in the oven atmosphere and then a controller may signal one or more of the variable speed fans, particularly, the auxiliary fan, to control the speed and/or flow of the fan(s) to maintain an opacity set point, including maintaining an opacity set point within a tolerance range. As another example, the air temperature near the entrance opening and/or near the exit opening may be measured by a first temperature sensor and the plant ambient temperature may be measured by a second temperature located away from the opening(s) of the oven enclosure. The first temperature sensor may be located, for example, directly above the oven enclosure entrance opening outside the oven. The difference between the two measured temperatures may give an indication of how well heat is being contained within the oven and may be used to control the speed and/or flow of one or more of the variable speed fans, particularly the vestibule fan(s).

Thus, according to this disclosure, a method of making an oven for heating and/or curing products is provided. The method may comprising determining how much exhaust capacity is needed to meet a combustion requirement for the oven, determining how much exhaust capacity is needed to meet a containment requirement for the oven, determining how much exhaust capacity is needed to meet a solvent removal requirement for the oven, determining how much exhaust capacity is needed to meet a turnover requirement for the oven, and determining how much exhaust capacity is needed to meet a purge requirement for the oven.

The method may further comprise providing the oven with at least one vestibule fan that at least meets the containment requirement, providing the oven with a fixed-speed exhaust fan that at least meets the combustion air requirement or the solvent removal requirement, whichever is larger, and providing the oven with a variable speed auxiliary fan that, when operating at a maximum speed, at least meets the turnover requirement or the purge requirement, whichever is larger, minus the combustion air requirement or the solvent removal requirement, whichever is larger. The containment requirement may be determined, at least in part, based on oven opening sizes. The purge requirement may be determined, at least in part, based on the desired purge time.

The method may further optionally include providing an air seal fan that operates to re-circulate a mixture of air from a heating zone of an enclosure chamber of an enclosure of the oven and from a vestibule of at an end of the enclosure. The method may further comprise mounting the at least one vestibule fan, the fixed speed exhaust fan, and the variable speed auxiliary fan to an oven enclosure of the oven, such as mounting to a top wall of the oven enclosure. The method may further comprise providing variable frequency drives for the auxiliary fan and the at least one vestibule fan.

In those embodiments in which the oven enclosure has vestibules at opposite open ends of the oven enclosure and in which the at least one vestibule fan includes a first vestibule fan and a second vestibule fan, the method may further comprise placing the first vestibule fan in communication with one of the vestibules and placing the second vestibule fan in communication with the other of the vestibules. The method may further comprise placing the exhaust fan and the auxiliary fan in communication with the heating zone of the oven enclosure.

The types of ovens contemplated herein are oftentimes used in industrial settings, such as factories, and use combustible fuels such as natural gas as the heating source. By providing one or more variable speed auxiliary fans in conjunction with at least one fixed speed exhaust fan for exhausting air from the heating zone of the oven chamber, less fuel is consumed under some operating circumstances thereby reducing overall operating costs of the oven due to fuel conservation.

Additional features will become apparent to those skilled in the art upon consideration of the following detailed description of illustrative embodiments exemplifying the best mode of carrying out various oven apparatuses and design methods as presently perceived.

### BRIEF DESCRIPTION OF THE DRAWINGS

The detailed description particularly refers to the accompanying figures in which:

FIG. 1 is a cross sectional view of an oven apparatus according to this disclosure showing a set of exhaust fans mounted atop an oven housing;

FIG. 2 is a diagrammatic view showing an opacity sensor arranged to measure the opacity of exhaust from an oven enclosure and the opacity sensor being coupled to a controller that controls the operation of a variable speed fan based on a signal received from the opacity sensor; and

FIG. 3 is a diagrammatic view showing a first temperature sensor situated near an opening of the oven enclosure, a second temperature situated away from the opening of the oven enclosure to measure an ambient plant temperature, and a controller that that receives first and second signals from the first and second temperature sensors, respectively, that controls a variable speed fan based on a difference between the first and second temperatures represented by the first and second signals.

### DETAILED DESCRIPTION

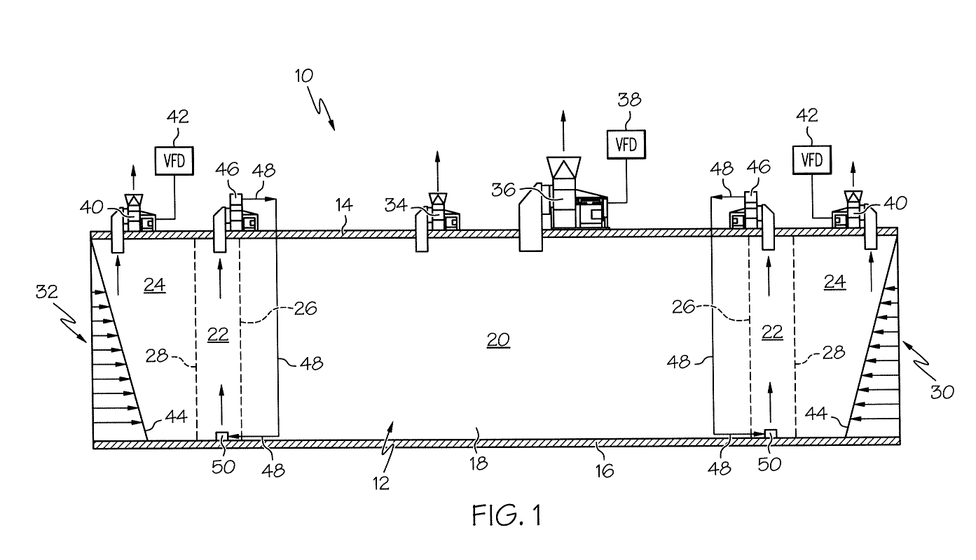

An oven apparatus 10 according to this disclosure comprises an oven enclosure 12 as shown in FIG. 1. Typically, the enclosure 12 is formed from insulated walls to minimize heat loss from the oven, but it is within the scope of this disclosure for one or more of the walls of oven enclosure 12 to be un-insulated. In the illustrative example, the oven enclosure 12 includes a generally horizontal top wall 14, a generally horizontal bottom wall 16, and a pair of generally vertical side walls 18 interconnecting top and bottom walls 14, 16. Only one of side walls 18 is shown in FIG. 1.

Typically, a conveyor (not shown) is used to carry a continuous or intermittent supply of product into the oven 10 to be cured or heat treated. In the illustrative embodiment, the product moves via the conveyor into the oven enclosure 12 through an entrance opening 30 at one end of oven enclosure 12 and leaves the oven enclosure 12 through an exit opening 32 provided at the other end of oven enclosure 12 after the curing or heat treating operation. Partial end walls, doors, straps, and the like (not shown) may be provided at openings 30, 32 in some embodiments, to partially block openings 30, 32 but that need not be the case such that the openings 30, 32 at the ends of oven enclosure 12 may be generally wide open in some embodiments. The product to be heat treated or cured may be placed in bins that are moved through oven enclosure 12 by the conveyor or placed on racks that are moved through oven enclosure 12 by the conveyor or may simply rest upon the conveyor individually or in piles.

In other embodiments, oven enclosure 12 has an end wall (not shown) in lieu of having exit opening 32 such that the conveyor makes a U-turn or multiple turns within the oven. In such alternative embodiments, therefore, the parts or product to be heat treated or cured enter and exit the oven enclosure through opening 30. In still other embodiments, separate entrance and exit opening are provided but are next to each other.

In the illustrative embodiment of FIG. 1, the interior of oven chamber 12 is divided into a heating zone 20 where the heating process occurs, air seal sections 22 that reduce the exchange of air between the heating zone 20 of the oven chamber and the air outside the oven enclosure 12, and vestibule sections 24 that capture fumes and heat that otherwise would have a tendency to escape from the oven 10 through the ends. In some embodiments, air seal sections 22 are omitted. In some embodiments, vestibule sections 24 are omitted. In the illustrative example, zone 20 and sections 22, 24 cooperate to form the overall oven chamber 20, 22, 24 of oven enclosure 12. In those embodiments in which air seal sections 22 are omitted, the remaining heating zone 20 and vestibule sections 24 cooperate to provide the oven chamber 20, 24 of the oven enclosure 12. In oven enclosure embodiments in which parts enter and exit oven enclosure 12 through opening 30 or have entrance and exit openings that are near each other, oven enclosure 12 may have only a single vestibule section 24 adjacent the opening(s).

It will be appreciated that piping, nozzles, burners, and the like (not shown) are provided within heating zone 20 and may be configured in any number of ways within heating zone 20 depending upon the particular application as is known in the art. Combustible fuel such as natural gas flows through the piping, nozzles, burners, and so forth and is ignited within heating zone 20 to provide the source of heat within oven 10.

Diagrammatically in FIG. 1, and for ease of discussion, dotted lines 26 are provided to indicate the boundaries between heating zone 20 and respective air seal sections 22 and dotted lines 28 are provided to indicate the boundaries between air seal sections 22 and respective vestibule sections 24. It should be understood that the dotted lines 26, 28 are simply diagrammatic in nature and that the precise locations of the boundaries between the various sections 20, 22, 24 of oven enclosure 12 may be difficult to discern under any given set of operating conditions. In other embodiments, partitions such as partial walls are provided within oven enclosure 12 to clearly demarcate and define the sections 20, 22, 24 of oven enclosure 12.

According to this disclosure, a number of exhaust fans are provided as will be further discussed below and are selected according to oven design criteria as also further discussed below. Some of the exhaust fans are fixed speed fans and others of the exhaust fans are variable speed fans. The use of variable speed fans in conjunction with fixed speed fans, as discussed below, is believed to be an improvement over known prior art oven systems in that, under some operating conditions, the total amount of air being exhausted from the oven can be reduced, but yet all regulatory and insurance underwriter requirements can continue to be met, which ultimately results in a cost savings due to reduced fuel consumption.

Oven apparatus 10 includes an exhaust fan 34 that is in communication with heating zone 20 of oven enclosure 12 and that is operable to exhaust or extract air from heating zone 20. Exhaust fan 34 is a fixed speed fan, the capacity of which is chosen so as to meet a combustion air requirement of oven 10 or a solvent removal requirement of oven 10, whichever is larger. Those skilled in the art will appreciate that a number of factors determine the solvent air requirement and/or the combustion air requirement including oven operating temperature, solvent type, oven volume, part surface area, conveyor speed and so forth. Details regarding calculating the solvent air requirement and the combustion air requirement are known to those skilled in the art and may also be found in the National Fire Protection Associations' NFPA 86 Standard for Ovens and Furnaces, 2007 Edition which is hereby incorporated by reference herein in its entirety.

Oven apparatus 10 also includes an auxiliary fan 36 that is in communication with heating zone 20 of oven enclosure 12 and that is operable to assist exhaust fan 34 in extracting or exhausting air from heating zone 20. In some instances, auxiliary fan 36 assists exhaust fan 34 in purging the oven enclosure 12 in a minimum amount of time. As noted above, the purge requirement is sometimes defined as removing an amount of air from the oven equal to four times the volume of the oven but it is not intended that the terms “purge” or “purge requirement” as used in this disclosure and in the claims be limited to this particular multiple of the oven volume unless specifically so noted. Thus, by knowing the volume of the oven enclosure 12 and knowing the amount of time that one wishes or is required to complete a purge of the oven, the exhaust capacity of auxiliary fan 36 can be determined. An oven designer may select an auxiliary fan 36 that, when operating at its maximum speed to assist the exhaust fan 34 in purging the oven enclosure 12, just meets the purge requirement thereby minimizing the cost of the pair of fans 34, 36 by not paying more for an auxiliary fan 36 having excess capacity (i.e., capacity more than that needed to meet the calculated purge requirement). Of course, that is not to say that an auxiliary fan 36 having more capacity than necessary couldn't be chosen, if desired or if other design considerations dictate otherwise as discussed below.

Auxiliary fan 36 may also be used along with exhaust fan 34 during normal heat treating and/or curing operations of oven 10. According to this disclosure, auxiliary fan 36 is a variable speed fan, the speed of which may be controlled using a variable frequency drive 38, for example. During normal operation of oven 10, fan 36 may be used in conjunction with exhaust fan 34 for turnovers which, as noted above, are not governed by regulatory bodies or insurance underwriters. Therefore, during normal operation, the speed of auxiliary fan 36 will oftentimes be less than its maximum speed and may be varied and adjusted down to minimize energy consumption, thereby reducing fuel consumption, but at the same time assisting with the turnover of oven 10.

As noted above, the oven exhaust turnover is the exchange of air needed to control the concentration of contaminants and, during normal operation, oftentimes dictates the amount of exhaust from oven 10 needed to prevent the coating on the parts from becoming discolored or otherwise adversely being affected by the contaminants to which the parts are exposed in the oven. As such, the turnover requirement may vary depending on the coating used, the coating thickness, square footage processed in the oven, the color of the parts, or many other reasons and, as also noted above, determining the turnover requirement for any particular application may occur on a trial and error basis. That being said, there is the possibility that auxiliary fan 36 may actually need to have more capacity and/or operate at a greater speed than calculated when determining the purge requirement. Ultimately therefore, when designing a particular oven, it is contemplated by this disclosure that the auxiliary fan 36 is chosen so as to meet the purge requirement or the turnover requirement, whichever is larger. It is also contemplated by this disclosure that more than one auxiliary fan 36 may be provided in communication heating zone 20 rather than just having a single auxiliary fan 36.

Oven 10 further has a pair of vestibule fans 40, each of which is in communication with a respective vestibule 24 to extract or exhaust air from the vestibule 24. Vestibule fans 40 are variable speed fans, the speeds of which are controlled by respective variable frequency drives 42. In general, it is contemplated that vestibule fans 40 are operated at a sufficient speed to counteract the chimney effect that would otherwise exist at the openings 30, 32 of oven enclosure 12 during heat treating and/or curing operations. Thus, vestibule fans 42 are operated as sufficient speed so as to contain any fumes that would otherwise migrate from the oven enclosure 12 through opening 30, 32 into the ambient surroundings near oven 10. It will be appreciated, therefore, that operation of vestibule fans 42 results in some air being drawn into the oven from the ambient surroundings. The vestibule fans 42 typically will be operating to exhaust from the respective vestibules 24 a mixture of ambient air and any fumes that move into vestibules 24 from heating zone 20 or from air seal section 22, if present.

A variable frequency drive, which also may be referred to as a variable frequency controller, is an electrical device that is typically located in or associated with a control panel or control housing that is remote from the motor it controls. Such is the case with variable frequency drives 38, 42 disclosed herein. Variable drives 38, 42 varies the frequency of alternating current sent to the associated motors of the variable speed fans 36, 40 resulting in motor speed changes.

In FIG. 1, a diagrammatic temperature and/or pressure gradient line 44 is provided adjacent openings 30, 32 along with a series of arrows that extend from openings 30, 32 to the pressure/temperature gradient line 44 to indicate that more ambient air is drawn into oven enclosure 12 near bottom wall 16 of oven enclosure 12 than near the top wall 14 of oven enclosure 12. This is due to the chimney effect that has a tendency to occur in oven chamber 20, 22 (if present), 24 due to hot air rising within the oven enclosure 12.

Illustrative oven 10 further has a pair of air seal fans 46, although, as has been noted already, these air seal fans 46 are optional. Air seal fans 46 are in communication with air seal sections 22 and are operable to create an air curtain or barrier between heating zone 20 and vestibules 24 to minimize or reduce the exchange of the atmosphere inside the oven with the atmosphere outside of the oven and vice versa. The air seal section 22 provided due to the operation of air seal fans 46 may also improve temperature uniformity in the oven by mixing the oven atmosphere with the incoming exhaust make up air. Thus, the air seal fans 46 create at least one impediment to heat loss within the oven enclosure 12.

In some embodiments, the air seal fans 46 are fixed speed fans. In other embodiments, the air seal fans 46 are variable speed fans that have associated variable frequency drives, for example. As indicated by series of arrows 48 in FIG. 1, air that is exhausted from the air barrier section 22 of the oven enclosure 12 by the respective air seal 46 fan is re-circulated back into the oven chamber and enters the oven enclosure near the bottom wall 16 of enclosure 12 through a respective opening or port 50. In practice, oven apparatus 10 includes appropriate duct work to route the air exhausted by fans 46 to the associated port 50. This type of air seal arrangement is sometimes referred to an inverted curtain air seal.

In the illustrative example of oven 10, vestibules 24 having associated vestibule fans 40 are provided adjacent both openings 30, 32 of oven enclosure 12 and air seal sections 22 having associated air seal fans 46 are provided between vestibules 24 and heating zone 20. It is within the scope of this disclosure for an oven to have only a single vestibule 24 with the associated vestibule fan 42 adjacent only one or the other of openings 30, 32 of oven enclosure 12 and to include or to omit an associate air seal section 22 with the associated air seal fan 46. An oven may be configured according to these alternative arrangements when another oven or other piece of industrial equipment is situated immediately adjacent the opening 30, 32 which lacks a vestibule 24.

With regard to controlling the speed of the variable speed fans included in oven apparatus 10, it is contemplated by this disclosure that, in some embodiments, a user can directly select the fan speed via a user input and that the user can speed up or slow down the fan speed of the variable speed fans via manipulation or adjustment of the user input. Such a user input may include, for example, a knob or dial on a control panel or a digital display, such as a touch screen display, associated with a logic-based controller, such as a computer or programmable logic controller (PLC). In some embodiments, the variable speed fans d36, 40 each have a 4:1 turndown ratio.

It is also contemplated by this disclosure, however, that the speed of the variable fans of oven apparatus 10 may be feedback controlled so as adjust the speed of the variable speed fans in a manner so as to automatically maintain at a set point (within a tolerance range) a characteristic of the oven 10 or a characteristic associated with the oven 10. In such a feedback control system, a sensor is provided to monitor the characteristic(s) which are processed to determine whether fan speed adjustments up or down are necessary.

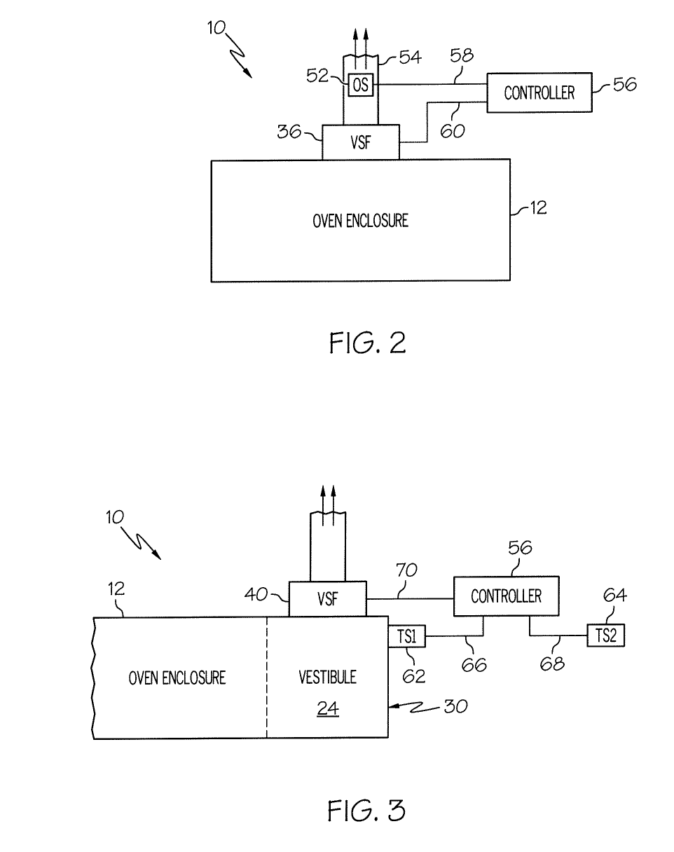

Referring now to FIG. 2, one example of a feedback control system for controlling the speed of the auxiliary fan 36 of oven apparatus 10 is shown diagrammatically. In FIG. 2, auxiliary fan 36 is simply indicated by a single block labeled “VSF” for “variable speed fan” and the variable frequency drive 38 shown in FIG. 1 is omitted from FIG. 2 to indicate that the present disclosure contemplates fan controls other than variable frequency drives. Such other variable speed van controls may include, for example, a pulse width modulation (PWM) controller or a proportional-integral-derivative (PID) controller. As shown in FIG. 2, an opacity sensor 52 is provided within an exhaust duct 54 through which the exhaust from auxiliary fan 36 flows. Other components of oven apparatus 10 that are not salient to the discussion of the feed back control of auxiliary fan 36 are omitted from FIG. 2 for ease of illustration.

Opacity sensor 52 senses the opacity of the exhaust within duct 54 which correlates to the concentration of contaminants entrained within the exhaust. The opacity sensed by sensor 52 is communicated as an output signal to a controller 56 as indicated diagrammatically by line 58 in FIG. 2. Controller 56 processes the output signal and determines whether auxiliary fan 36 needs to be sped up (e.g., if the concentration of contaminants in the exhaust is determined to be too high or above the set point by controller 56) or slowed down (e.g., if the concentration of contaminants in the exhaust is determined to be too low or below the set point by controller 56). Controller 56 then provides an input signal to fan 36 to adjust the speed of fan 36 as indicated diagrammatically by line 60 in FIG. 2. The particular opacity set point that controller 56 controls fan 36 to maintain will be application-specific and may need to be determined by trial and error in some instances. That is, the quality of the finish or coating on the product exiting oven enclosure 12 may need to be inspected and the control of fan 36 adjusted until a suitable finish or coating on the part is achieved.

While this disclosure contemplates fan controller system that use approaches other than variable frequency drives, one advantage of using is a variable frequency drive for fan speed control is that variable frequency drives have a substantially linear response characteristic thereby allowing for better fan control, which is especially important for controlling oven turnover. Also, variable frequency drives have an advantage over use of dampers within ducts to control turnover since damper action results in non-linear control.

While opacity sensor 52 is shown diagrammatically as a single block in FIG. 2, those skilled in the art will appreciate that some opacity sensors have one or more emitters such as one or more light emitters, including possibly one or more infrared (IR) light emitters, and one or more receivers such as one or more light receivers, including possibly one or more IR receivers. Furthermore, opacity sensor 52 may include circuitry that controls the light emitter(s) and does some amount of processing of signals received from the receiver(s) prior to communicating an output signal to controller 56. Some known opacity sensors use light scattering principles and have circuitry that compares the intensity of light emitted to the intensity of light received to determine the opacity of a substance, in this case exhaust gas, located between the emitter(s) and receiver(s). Use of such opacity sensors as opacity sensor 52 of oven apparatus 10 are contemplated by this disclosure.

Referring now to FIG. 3, one example of a feedback control system for controlling the speed of the vestibule fan 36 of oven apparatus 10 is shown diagrammatically. In FIG. 3, as was the case with FIG. 2, vestibule fan 36 is simply indicated by a single block labeled “VSF” for “variable speed fan” and the variable frequency drive 42 shown in FIG. 1 is omitted from FIG. 3 to indicate that the present disclosure contemplates fan controls other than variable frequency drives such as, for example, a PWM controller or a PID controller as mentioned previously. Other components of oven apparatus 10 that are not salient to the discussion of the feed back control of vestibule fan 40 are omitted from FIG. 3 for ease of illustration. The discussion below of one exemplary feedback system to control the speed of vestibule fan 40 located near opening 30 of oven enclosure is equally applicable to the vestibule fan located near opening 32.

As shown in FIG. 3, a first temperature sensor 62 is located adjacent oven enclosure 12 near the top of opening 30 to measure the air temperature near opening 30 just outside of oven enclosure 12 and a second temperature sensor 64 is located outside the oven enclosure 12 a suitable distance and location away from the opening 30 to measure the plant ambient temperature. Temperature sensor 62 may be placed at other locations near opening 30, but placing it at or near the top of opening 30 will tend to yield the highest temperature reading to indicate the amount of air, or at least heat, escaping oven enclosure 12. A first temperature signal is communicated from sensor 62 to controller 56 as indicated diagrammatically by line 66 in FIG. 3 and a second temperature signal is communicated from sensor 64 to controller 56 as indicated diagrammatically by line 68 in FIG. 3. Controller 56 is configured to calculate the difference between the two temperatures measured by sensors 62, 64 and communicated via lines 66, 68 to controller 56. The temperature difference provides an indication of how well heat is being contained within the oven enclosure 12 and is used to control the speed of vestibule fan 40. Thus, based on the difference in temperatures sensed by sensors 62, 64, controller 56 provides an input signal to vestibule fan 40 as indicated diagrammatically by line 70 in FIG. 3, to speed up (i.e., if the temperature difference is too great) or to slow down (i.e., if the temperature difference is too small).

In those embodiments in which air seal fan 46 is a variable speed fan, it is contemplated by this disclosure that a temperature sensor may be placed in the ductwork associate with the recirculation path 48 and the speed of fan 46 controlled by a suitable controller to maintain a set point temperature as sensed by the temperature sensor (within a tolerance range). It should also be appreciated that the controller 56 which controls the speeds of fans 36, 40 may also be used to provide an on signal or an off signal to the fixed speed fans, such as exhaust fan 34 and the air seal fans 46 in those embodiments in which one or more of air seal fans 34 are present and are fixed speed fans.

Although the same controller 56 is shown in FIGS. 2 and 3 as providing signals on lines 58, 70 to control the speeds of respective fans 36, 40, in other embodiments, separate controllers may be used to control fans 36, 40 if desired. Furthermore, different ones of these separate controllers may be used to provide an on signal and an off signal to associated ones of the fixed speed fans of oven apparatus 10.

Based on the foregoing, it can be seen that this disclosure contemplates a method of making an oven that may be operated in a manner that saves fuel consumption. The method includes determining how much exhaust capacity is needed to meet a combustion requirement for the oven, determining how much exhaust capacity is needed to meet a containment requirement for the oven, determining how much exhaust capacity is needed to meet a solvent removal requirement for the oven, determining how much exhaust capacity is needed to meet a turnover requirement for the oven, and determining how much exhaust capacity is needed to meet a purge requirement for the oven. Based on these determinations, an oven designer or manufacturer then may proceed to provide the oven with at least one vestibule fan that at least meets the containment requirement; provide the oven with a fixed-speed exhaust fan that at least meets the combustion air requirement or the solvent removal requirement, whichever is larger; and provide the oven with a variable speed auxiliary fan that, when operating at a maximum speed, at least meets the turnover requirement or the purge requirement, whichever is larger, minus the combustion air requirement or the solvent removal requirement, whichever is larger.

By employing the oven design methodology of the present disclosure, an oven apparatus 10 can be optimized for a minimum operating cost, particularly with regard to fuel consumption, but that still operates safely, meets all NFPA requirements and requirements from insurance underwriters (e.g., Factory Mutual, Industrial Risk Insurers), and that provides suitable capacity for containment, turnovers, and fast purge times. It has been estimated that an oven designed in accordance with the present disclosure may save up to 40% or more compared to an oven made according to currently known design methodologies. This savings is attributable in large part to having a variable speed auxiliary fan 36 used in conjunction with exhaust fan 34 to exhaust heating zone 20 (e.g., fan 34 meets NFPA and insurance requirements by itself for combustion air and solvent removal requirements so the speed of fan 36 can be lowered to meet turnover requirements) and by having separate variable speed vestibule fans 40 for containment of oven atmosphere allows for lowered temperature of the air exhausted by these separate fans 40 because the air exhausted will be a mixture of oven air and plant air.

Although certain illustrative embodiments have been described in detail above, variations and modifications exist within the scope and spirit of this disclosure as described and as defined in the following claims.

1. An apparatus for heating and/or curing products, the apparatus comprising
an oven enclosure having an oven chamber with a heating zone in which products are heated or cured,
an exhaust fan that extracts air from the heating zone of the oven chamber, and
at least one auxiliary fan that extracts air from the heating zone of the oven chamber, the exhaust fan being a fixed speed fan and the at least one auxiliary fan being a variable speed fan.

2. The apparatus of claim 1, wherein the speed of the auxiliary fan is increasable to increase oven exhaust turnover and the speed of the auxiliary fan is decreasable to decrease energy use.

3. The apparatus of claim 1, wherein the auxiliary fan is controlled based on a signal received from an opacity sensor operable to measure opacity of oven exhaust.

4. The apparatus of claim 1, further comprising at least one vestibule within the oven chamber, the vestibule being situated adjacent an opening in the oven enclosure through which products enter or exit the oven chamber, and at least one vestibule fan that extracts air from the at least one vestibule to capture at least a portion of oven atmosphere before the oven atmosphere escapes the opening of the oven enclosure.

5. The apparatus of claim 4, wherein the at least one vestibule fan is also an adjustable speed fan, the speed of the vestibule fan is increasable to increase vestibule exhaust so as to capture and remove an increased amount of contaminants and heat and the speed of the vestibule fan is decreasable to improve energy use.

6. The apparatus of claim 4, wherein the at least one vestibule fan is controlled based on a difference in temperature between a first temperature measured by a first temperature sensor located near the opening of the oven enclosure and a second temperature measured by a second temperature sensor located outside the oven enclosure away from the opening.

7. The apparatus of claim 4, wherein the at least one vestibule fan and the at least one auxiliary fan are each driven by respective variable frequency drives.

8. The apparatus of claim 4, further comprising at least one air seal fan that creates at least one barrier to heat loss within the oven chamber, the at least one barrier being situated between the at least one vestibule and the heating zone of the oven chamber.

9. The apparatus of claim 8, wherein the at least one air seal fan is also a fixed speed fan.

10. The apparatus of claim 9, wherein air exhausted from the barrier of the oven chamber by the air seal fan is re-circulated back into the oven chamber.

11. The apparatus of claim 10, wherein the oven enclosure has a top wall, the air seal fan is mounted to the top wall, and the air re-circulated by the air seal fan enters the barrier of the oven chamber near a bottom of the oven chamber.

12. The apparatus of claim 8, wherein the oven enclosure has a top wall and wherein the exhaust fan, the at least one auxiliary fan, and the at least one vestibule fan are each mounted to the top wall of the oven enclosure.

13. The apparatus of claim 8, wherein the exhaust fan has the capacity to operate so as to meet a combustion air requirement or a solvent removal requirement, whichever is larger.

14. The apparatus of claim 13, wherein the at least one vestibule fan has capacity to operate so as to meet a containment requirement.

15. The apparatus of claim 13, wherein the at least one auxiliary fan has capacity to operate so as to meet a turnover requirement or a purge requirement, whichever is larger, minus the larger of the combustion air requirement and the solvent removal requirement.

16. A method of making an oven for heating and/or curing products, the method comprising
determining how much exhaust capacity is needed to meet a combustion requirement for the oven,
determining how much exhaust capacity is needed to meet a containment requirement for the oven,
determining how much exhaust capacity is needed to meet a solvent removal requirement for the oven,
determining how much exhaust capacity is needed to meet a turnover requirement for the oven,
determining how much exhaust capacity is needed to meet a purge requirement for the oven,
providing the oven with at least one vestibule fan that at least meets the containment requirement,
providing the oven with a fixed-speed exhaust fan that at least meets the combustion air requirement or the solvent removal requirement, whichever is larger, and
providing the oven with a variable speed auxiliary fan that, when operating at a maximum speed, at least meets the turnover requirement or the purge requirement, whichever is larger, minus the combustion air requirement or the solvent removal requirement, whichever is larger.

17. The method of claim 16, wherein the containment requirement is determined, at least in part, based on oven opening sizes.

18. The method of claim 16, wherein the purge requirement is determined, at least in part, based on the desired purge time.

19. The method of claim 16, further comprising providing an air seal fan that operates to re-circulate a mixture of air from a heating zone of an enclosure chamber of an enclosure of the oven and from a vestibule of at an end of the enclosure.

20. The method of claim 16, further comprising mounting the at least one vestibule fan, the fixed speed exhaust fan, and the variable speed auxiliary fan to an oven enclosure of the oven.

21. The method of claim 16, further comprising mounting the at least one vestibule fan, the fixed speed exhaust fan, and the variable speed auxiliary fan to a top wall of an oven enclosure of the oven.

22. The method of claim 16, further comprising providing variable frequency drives for the auxiliary fan and the at least one vestibule fan.

23. The method of claim 16, wherein the oven has an oven enclosure with vestibules included at opposite open ends of the oven enclosure, the oven enclosure has a heating zone located in the oven enclosure between the vestibules, the at least one vestibule fan includes a first vestibule fan and a second vestibule fan, and the method further comprising placing the first vestibule fan in communication with one of the vestibules, placing the second vestibule fan in communication with the other of the vestibules, and placing the exhaust fan and the auxiliary fan in communication with the heating zone.
